(19) United States
(12) Patent Application Publication
(10) Pub. No.: US 2025/0180417 A1
(43) Pub. Date: Jun. 5, 2025

(54) STRAIN GAUGE, METHOD FOR PRODUCING STRAIN GAUGE, AND STRAIN SENSOR

(71) Applicant: Alps Alpine Co., Ltd., Tokyo (JP)

(72) Inventors: Yosuke IDE, Niigata-ken (JP); Masakazu SERA, Niigata-ken (JP); Mitsuji YANO, Niigata-ken (JP)

(21) Appl. No.: 19/035,167

(22) Filed: Jan. 23, 2025

Related U.S. Application Data
(63) Continuation of application No. PCT/JP2023/007235, filed on Feb. 28, 2023.

(30) Foreign Application Priority Data
Aug. 12, 2022 (JP) 2022-128843

(51) Int. Cl. G01L 1/22

(52) U.S. Cl. CPC G01L 1/2287

(57) ABSTRACT

One disclosed aspect of the present invention is directed to providing a strain gauge including a first laminate. The first laminate includes a strain resistance layer disposed over a resin-based substrate, the strain resistance layer being Cr-based and having a body-centered cubic structure, a first layer disposed between the resin-based substrate and the strain resistance layer, and a second layer disposed between the strain resistance layer and the first layer, the second layer serving as a base layer for forming the strain resistance layer. The first layer inhibits the diffusion of oxygen from the resin-based substrate to the strain resistance layer. The second layer inhibits the crystal growth of the strain resistance layer due to the crystal structure of the first layer.

### CLAIM OF PRIORITY

This application is a Continuation of International Application No. PCT/JP2023/007235 filed on Feb. 28, 2023, which claims benefit of Japanese Patent Application No. 2022-128843 filed on Aug. 12, 2022. The entire contents of each application noted above are hereby incorporated by reference.

### BACKGROUND OF THE INVENTION

### 1. Field of the Invention

The present invention relates to a strain gauge and a strain sensor.

### 2. Description of the Related Art

Japanese Patent No. 6793103 discloses a strain gauge including a flexible resin substrate, a functional layer that is disposed directly on one surface of the substrate and that is composed of a metal, an alloy, or a metal compound, and a resistor that is disposed directly on one surface of the functional layer and that is formed of a film containing Cr, CrN, and Cr₂N, in which the resistor contains α-Cr as a main component, and the functional layer has the function of promoting the crystal growth of the α-Cr to form a film containing the α-Cr as a main component.

In the invention disclosed in Japanese Patent No. 6793103, the functional layer is disposed for stabilizing the gauge characteristics of the strain gauge, has the function of promoting the crystal growth of the resistor, and may have the function of inhibiting the oxidation of the resistor due to oxygen and moisture and the function of improving the adhesion between the substrate and the resistor.

The “functional layer” disclosed in Japanese Patent No. 6793103 is preferred from the viewpoint of improving the adhesion of the strain resistance layer to a resin-based substrate composed of, for example, a polyimide resin. Studies by the inventors have revealed that the gauge factor of the strain resistance layer decreases when the strain resistance layer is formed on the functional layer, which will be described in detail below.

In light of the above circumstances, the present invention provides a strain gauge that can have improved adhesion to a resin-based substrate with the gauge factor maintained. The present invention also provides a strain sensor that includes the strain gauge and that can measure strain with high accuracy even when the strain-generating body is small.

### SUMMARY OF THE INVENTION

One disclosed aspect of the present invention is directed to providing a strain gauge including a first laminate. The first laminate includes a strain resistance layer disposed over a resin-based substrate, the strain resistance layer being Cr-based and having a body-centered cubic structure, a first layer disposed between the resin-based substrate and the strain resistance layer, and a second layer disposed between the strain resistance layer and the first layer, the second layer serving as a base layer for forming the strain resistance layer. The first layer inhibits the diffusion of oxygen from the resin-based substrate to the strain resistance layer. The second layer inhibits the crystal growth of the strain resistance layer due to the crystal structure of the first layer.

The inventors have investigated the reason why the “functional layer” disclosed in Japanese Patent No. 6793103 reduces the gauge factor of the strain resistance layer and have obtained the following findings.

The cause of the decrease in adhesion is the diffusion of oxygen from the resin-based substrate to the strain resistance layer. The “functional layer” disclosed in Japanese Patent No. 6793103 is a layer having a higher atomic packing density than the strain resistance layer; hence, the functional layer promotes the crystal growth of the body-centered cubic structure of the strain resistance layer and also functions as an oxygen barrier layer.

However, when a strain resistance layer is formed directly on a layer having a high atomic packing density as disclosed in Japanese Patent No. 6793103, the crystallinity of the strain resistance layer is high. A higher crystallinity of the strain resistance layer results in lower responsiveness of a resistance change to strain, leading to a decrease in gauge factor. In this way, when the strain resistance layer is formed on the “functional layer” as a base, the crystal growth of the strain resistance layer is promoted because of the crystal structure of the “functional layer”.

As a result of further studies based on the above findings, the inventors have obtained new findings that a decrease in the gauge factor of a strain gauge is inhibited by providing a layer (first layer) having an oxygen barrier function between a resin-based substrate and a strain resistance layer and using, as a base layer, a layer (second layer) that inhibits the crystal growth of a body-centered cubic structure in the strain resistance layer, instead of using the first layer as a base layer when the strain resistance layer is formed.

In the above-mentioned strain gauge, the crystallinity of the strain resistance layer in the first laminate is preferably lower than the crystallinity of a strain resistance layer formed using the first layer as a base layer, from the viewpoint of ensuring a sufficient gauge factor.

In the above-mentioned strain gauge, the second layer may preferably have a thickness of 1.5 nm or more and 10 nm or less.

In the above-mentioned strain gauge, the second layer may be composed of a Cr-based material. In this case, the second layer may contain a second element that is an element other than Cr.

When the second layer contains the second element, the second element may include a main-group element or may include one or more elements selected from the group consisting of group 12 elements to group 15 elements. The Pauling electronegativity of the second element may preferably higher than that of Cr and may further preferably meet 2.6 or less.

In the above-described strain gauge, the second layer may preferably be wet-etchable with an etching solution used for wet-etching the strain resistance layer.

In the above-mentioned strain gauge, the first layer may contain a first element having a higher Pauling electronegativity than Cr. In this case, the first layer may preferably be composed of a metal based on the first element or an alloy based on the first element.

In the above-mentioned strain gauge, the first layer preferably has a composition that forms a face-centered cubic lattice structure or a hexagonal close-packed structure.

In the above-mentioned strain gauge, the first layer may preferably be wet-etchable with an etching solution used for wet-etching the strain resistance layer.

Another aspect of the present invention is directed to providing a strain sensor including the above-mentioned strain gauge and an electrode for energizing the strain gauge.

### BRIEF DESCRIPTION OF THE DRAWINGS

FIG. 1 illustrates an example of a strain sensor according to an embodiment of the present invention;

FIG. 2 is a schematic cross-sectional view taken along line II-II in FIG. 1;

FIG. 3 is a cross-sectional view illustrating the structure of a strain gauge according to an embodiment of the present invention;

FIG. 4 illustrates X-ray diffraction spectra of strain gauges according to examples; and

FIG. 5 is a graph illustrating the dependence of the gauge factor Gf of a strain gauge according to an example on the thickness of a second layer.

### DESCRIPTION OF THE PREFERRED EMBODIMENTS

Embodiments of the present invention will be described below with reference to the drawings. In the following description, the same members are denoted by the same signs, and duplicate description of the members that have been explained once is omitted as appropriate.

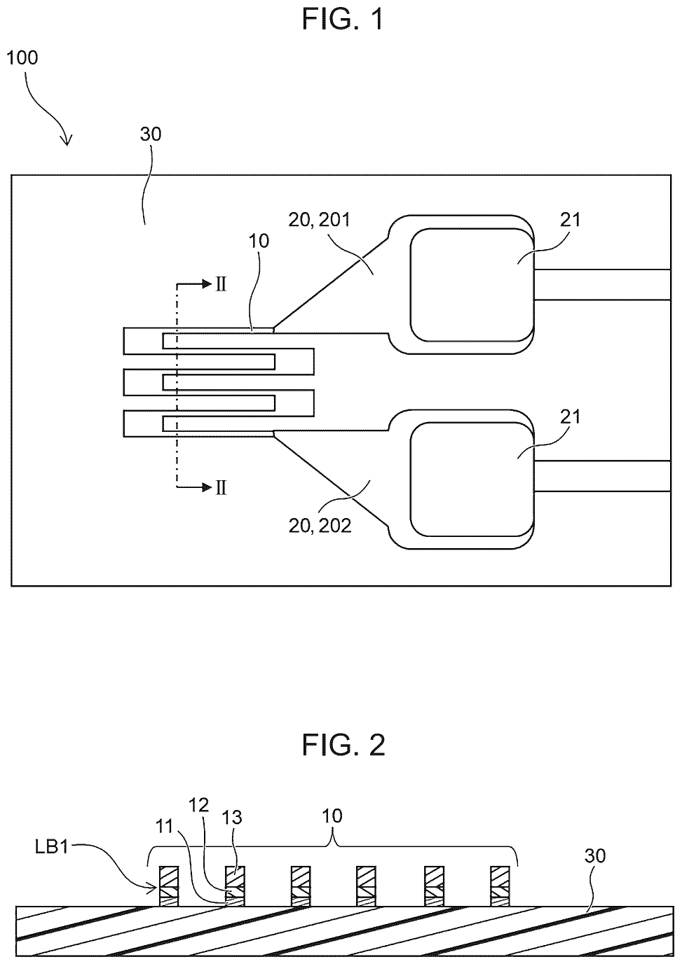

FIG. 1 illustrates an example of a strain sensor according to an embodiment of the present invention. As illustrated in FIG. 1, a strain sensor 100 according to the present embodiment includes a strain gauge 10 having a meandering pattern, and electrodes 20 for energizing the strain gauge 10. The strain gauge 10 and the electrodes 20 are all disposed on a resin-based substrate 30. Non-limiting examples of a constituent material of the electrodes 20 include Cu, Au, and alloys containing these. The electrodes 20 include a first electrode 201 connected to one end portion of the strain gauge 10 and a second electrode 202 connected to the other end portion. Each of the first electrode 201 and the second electrode 202 is provided with a plating 21 for the purpose of increasing the solder joint strength. Any constituent material can be used for the resin-based substrate 30 as long as it has a predetermined flexibility. A specific example of the constituent material is a polyimide resin.

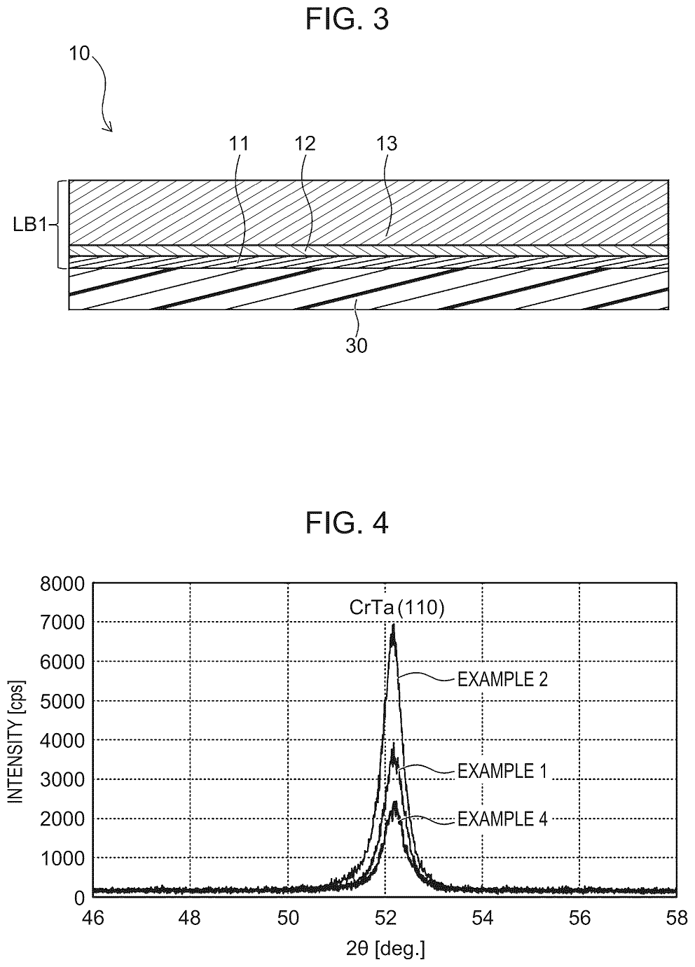

FIG. 2 is a schematic cross-sectional view taken along line II-II in FIG. 1. FIG. 3 is a cross-sectional view illustrating the structure of a strain gauge according to an embodiment of the present invention. As illustrated in FIG. 2, the strain gauge 10 includes a first laminate LB1 including a strain resistance layer 13, a first layer 11 disposed between the resin-based substrate 30 and the strain resistance layer 13, and a second layer 12 disposed between the strain resistance layer 13 and the first layer 11. FIG. 3 illustrates the structure of the first laminate LB1 in detail and corresponds to a partially enlarged view of FIG. 2.

The strain resistance layer 13 of the first laminate LB1 is composed of a Cr-based metallic material having a body-centered cubic structure. A specific example thereof is a Cr—Ta alloy that is Cr-based and contains a few atomic percent of Ta. The strain resistance layer 13 may be constituted of a material containing, for example, Cr as a main component and a nonmetallic element, specifically, a main-group element (for example, N).

The first layer 11 of the first laminate LB1 is composed of a metallic material having the function of inhibiting the diffusion of oxygen from the resin-based substrate 30 to the strain resistance layer 13. The first layer functions as an oxygen barrier layer and can inhibit a deterioration in the adhesion of the strain resistance layer 13 to the resin-based substrate 30. From the viewpoint of the oxygen barrier layer, the first layer 11 preferably has a higher atomic packing density than the strain resistance layer 13. Specifically, the first layer 11 preferably has a composition that forms a face-centered cubic (fcc) lattice structure or a hexagonal close-packed (hcp) structure.

From the viewpoint of appropriately functioning as an oxygen barrier layer, the first layer 11 may contain a first element having a higher Pauling electronegativity than Cr (1.66). In this case, the first layer may preferably contain a metal based on the first element or an alloy based on the first element.

Specific examples of a material constituting the first layer 11 include Ni (electronegativity: 1.91), Ni-based alloys (fcc structure), such as Ni—Cr alloys, Cu (electronegativity: 1.90), Cu—Ni alloys (fcc structure), Co (electronegativity: 1.88), and Co-based alloys (hcp structure), such as Co—Cr alloys.

The first layer 11 may be advantageously produced when the first layer 11 can be wet-etched with an etching solution, such as an ammonium cerium nitrate solution, used for wet-etching the strain resistance layer 13.

The second layer 12 of the first laminate LB1 serves as a base layer when the strain resistance layer 13 is formed, and has the function of inhibiting the crystal growth of the strain resistance layer 13. When the strain resistance layer 13 is formed directly on the first layer 11 that functions as an oxygen barrier layer, the high atomic packing density of the first layer 11 causes the strain resistance layer 13 to have high crystallinity due to this effect. For example, in the case of a Cr-based strain resistance layer 13, the (110) orientation of the body-centered cubic structure of the strain resistance layer 13 is excessively strong. A higher crystallinity of the strain resistance layer 13 results in lower responsiveness of the resistance change of the strain resistance layer 13 to strain, leading to a decrease in gauge factor Gf. The reason for the decrease in gauge factor Gf is presumably that the magnetovolume effect (the phenomenon in which magnetic properties and volume change while influencing each other), which is the reason why the Cr-based material has a relatively large gauge factor Gf, is less likely to be exerted as the atomic packing density increases.

Thus, the layer (first layer 11) having an oxygen barrier function is disposed between the resin-based substrate 30 and the strain resistance layer 13. The first layer 11 is not used as a base layer when the strain resistance layer 13 is formed, but the layer (second layer 12) that inhibits excessive crystal growth of the body-centered cubic structure in the strain resistance layer 13 is used as the base layer. This allows the crystallinity of the strain resistance layer 13 to be appropriately adjusted, and inhibits a decrease in the gauge factor Gf of the strain gauge 10. That is, the second layer 12 is a layer that inhibits the crystal growth of the strain resistance layer due to the crystal structure of the first layer.

From the viewpoint of stably inhibiting the decrease in the gauge factor Gf, the second layer 12 may preferably have a thickness of 1.5 nm or more and 10 nm or less.

The second layer 12 may be constituted of a Cr-based material. In this case, the second layer 12 may contain a second element that is an element other than Cr. When the second layer 12 contains the second element, the second element may include a main-group element or may include one or more elements selected from the group consisting of group 12 elements to group 15 elements. The second element may preferably have a higher Pauling electronegativity than Cr (1.66). For manufacturing and other reasons, the Pauling electronegativity of the second element may preferably meet 2.6 or less. Also, for the same manufacturing reasons, the second layer 12 is preferably wet-etchable with an etching solution used for wet-etching the strain resistance layer 13.

A specific example of a material constituting the second layer 12 is CrB in which B (electronegativity: 2.04) is contained as the second element. From the viewpoint of maintaining metallic properties, the B content may preferably be 40 at % or less, more preferably 30 at % or less.

The above embodiments are described in order to facilitate understanding of the present invention and are not intended to limit the present invention. Therefore, the elements disclosed in the above embodiments involve all design changes and equivalents that fall within the technical scope of the present invention.

The present invention will be described in detail with reference to examples.

### EXAMPLES

Strain gauges having structures given in Table 1 were produced. In Table 1, “NiCr” indicates a Ni—Cr alloy with a Cr content of 25 at %. “CuNi” indicates a Cu—Ni alloy with a Ni content of 45 at %. “Co” indicates Co metal.

TABLE 1

| | | | | | Strain | | Occurrence Of Film | |
|---|---|---|---|---|---|---|---|---|
| | | | | Second | Resistance | | Peeling After High- | |
| | First Layer | | | Layer | Layer | | Temperature And | |
| | NiCr | CuNi | Co | CrB | CrTa | | High-Humidity | |
| | (nm) | (nm) | (nm) | (nm) | (nm) | Gf | Storage | Remarks |
| Example 1 | 0 | 0 | 0 | 0 | 100 | 11.70 | yes | Reference |
| | | | | | | | | Example |
| Example 2 | 5 | 0 | 0 | 0 | 100 | 7.43 | no | Comparative |
| | | | | | | | | Example |
| Example 3 | 5 | 0 | 0 | 1.5 | 100 | 11.04 | no | Example |
| Example 4 | 5 | 0 | 0 | 3.0 | 100 | 11.79 | no | Example |
| Example 5 | 5 | 0 | 0 | 5.0 | 100 | 11.38 | no | Example |
| Example 6 | 5 | 0 | 0 | 10.0 | 100 | 10.32 | no | Example |
| Example 7 | 0 | 5 | 0 | 3.0 | 100 | 11.31 | no | Example |
| Example 8 | 0 | 0 | 5 | 3.0 | 100 | 11.14 | no | Example |

Specifically, the strain gauge according to Example 1 had a structure in which the strain resistance layer 13 was disposed directly on the resin-based substrate 30. The strain gauge according to Example 2 had a structure in which the strain resistance layer 13 was disposed on, as a base, the first layer 11 on the resin-based substrate 30.

In each of Examples 2 to 8, the first layer 11 composed of a material given in Table 1 was formed in a thickness given in Table 1 on the resin-based substrate 30 composed of a polyimide film. The second layer 12 composed of CrB with a B content of 30 at % and having a thickness given in Table 1 was formed on the first layer 11 disposed on the resin-based substrate 30. The strain resistance layer 13 composed of CrTa with a Ta content of 2 at % was formed on the second layer 12 as a base, thereby resulting in the strain gauge 10 in which the first laminate LB1 formed of the first layer 11, the second layer 12, and the strain resistance layer 13 was disposed on the resin-based substrate 30.

The resulting strain gauges 10 were subjected to X-ray diffraction measurement. The first layers 11 and the second layers 12 were thin; hence, no peaks based on these layers were observed in the spectra obtained by X-ray diffraction measurement. Only peaks based on the strain resistance layers 13 were observed.

FIG. 4 is a graph illustrating the X-ray diffraction spectra of the strain gauges according to examples. As illustrated in FIG. 4, in Example 4, in which the strain resistance layer 13 was disposed on the second layer 12 serving as a base, a peak corresponding to the (110) orientation of the body-centered cubic structure of the strain resistance layer 13 was weakly detected with reference to Example 1, in which the strain resistance layer 13 was disposed directly on the resin-based substrate 30. This revealed that the crystallinity of the strain resistance layer 13 in Example 4 was lower than that of the strain resistance layer 13 in Example 1. In contrast, in Example 2, in which the strain resistance layer 13 was disposed on the first layer 11 serving as a base, a peak corresponding to the (110) orientation of the body-centered cubic structure of the strain resistance layer 13 was strongly detected with reference to Example 1. This revealed that the crystallinity was higher than that of the strain resistance layer 13 in Example 4 and that of the strain resistance layer 13 in Example 1.

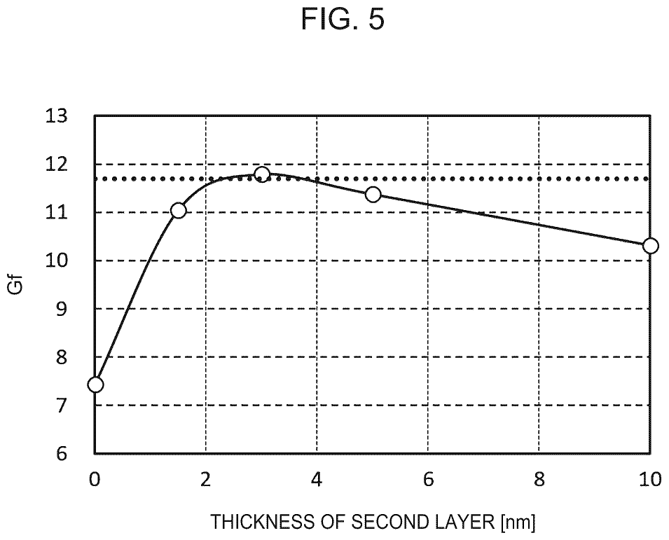

The resulting strain gauges were used to produce strain sensors 100. Their gauge factors Gf were measured. Furthermore, the strain sensors were subjected to a high-temperature and high-humidity environmental test at 85° C. and 85% relative humidity for 100 hours. After the test, the strain gauges were observed to evaluate whether the first laminates LB1 had peeled off from the resin-based substrates 30 (film peeling test). The measurement results of the gauge factors Gf and the results of the film peeling test are presented in Table 1 and FIG. 5. The dotted line in FIG. 5 indicates, for comparison, the gauge factor Gf (11.7) in Example 1 in which the strain resistance layer 13 was disposed directly on the resin-based substrate 30.

As presented in Table 1 and FIG. 5, the gauge factors Gf were increased when the second layers 12 were disposed, compared with when no second layer 12 was disposed. In particular, when the thickness of the gauge factor Gf was in the range of 1.5 nm or more and 10 nm or less, the results were equivalent to that in the case where the strain resistance layer 13 was directly disposed on the resin-based substrate 30 (Example 1).

1. A strain gauge, comprising:
a first laminate including:
a strain resistance layer disposed over a resin-based substrate, the strain resistance layer being Cr-based and having a body-centered cubic structure;
a first layer disposed between the resin-based substrate and the strain resistance layer, the first layer having a crystal structure; and
a second layer disposed between the strain resistance layer and the first layer, the second layer serving as a base layer for forming the strain resistance layer,
wherein the first layer inhibits a diffusion of oxygen from the resin-based substrate to the strain resistance layer, and the second layer inhibits a crystal growth of the strain resistance layer due to the crystal structure of the first layer.

2. The strain gauge according to claim 1, wherein a crystallinity of the strain resistance layer formed on the second layer is lower than a crystallinity of the strain resistance layer when the strain resistance layer is formed directly on the first layer using the first layer as a base layer.

3. The strain gauge according to claim 1, wherein the second layer has a thickness equal to or greater than 1.5 nm and equal to or smaller than 10 nm.

4. The strain gauge according to claim 1, wherein the second layer is composed of a Cr-based material and contains a second element that is an element other than Cr.

5. The strain gauge according to claim 4, wherein the second element includes a main-group element.

6. The strain gauge according to claim 4, wherein the second element includes at least one element selected from the group consisting of group 12 elements through group 15 elements.

7. The strain gauge according to claim 5, wherein the second element has a higher Pauling electronegativity than Cr.

8. The strain gauge of claim 7, wherein the second element has a Pauling electronegativity equal to or smaller than 2.6.

9. The strain gauge according to claim 1, wherein the second layer is wet-etchable with an etching solution for wet-etching the strain resistance layer.

10. The strain gauge according to claim 1, wherein the first layer contains a first element having a higher Pauling electronegativity than Cr.

11. The strain gauge according to claim 10, wherein the first layer is composed of a metal or alloy based on the first element.

12. The strain gauge according to claim 1, wherein the first layer has a composition forming a face-centered cubic lattice structure or a hexagonal close-packed structure.

13. The strain gauge according to claim 1, wherein the first layer is wet-etchable with an etching solution for wet-etching the strain resistance layer.

14. A strain sensor, comprising:
the strain gauge according to claim 1; and
an electrode for energizing the strain gauge.
